(19) United States
(12) Patent Application Publication
(10) Pub. No.: US 2007/0277235 A1
(43) Pub. Date: Nov. 29, 2007

(54) System and method for providing user authentication and identity management

(76) Inventors: Paul D. Barrett, Washington, DC (US); Andrew Ryan, East Sussex (GB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/637,934

(22) Filed: Dec. 13, 2006

Related U.S. Application Data
(63) Continuation of application No. 09/959,294, filed on Feb. 11, 2002.

(30) Foreign Application Priority Data
Apr. 22, 1999 (GB) 9909159.7

(51) Int. Cl. H04L 9/32

(52) U.S. Cl. 726/12

(57) ABSTRACT

A distributed client/server system comprises a network of servers and clients, such as the Internet, in which user access to certain restricted resources is controlled by a logon procedure that identifies an authorized user to the respective administering server. The disclosed system and method includes a logon server that comprises a user authentication procedure by which a user can logon to the logon server from any client in the network and uniquely identify itself to the logon server. The logon server also includes a library of usernames and passwords for the restricted resources chosen by each user and the ability to automatically log the users on to any of the restricted resources when selected by the user through a personal catalog maintained by the logon server. The disclosed system and method also includes various other features for providing user authentication and identity management in a network environment, such as the Internet.

### BACKGROUND OF THE INVENTION

I. Field of the Invention

The present invention generally relates to a system and method for providing network access to restricted resources. The invention also relates to a system and method for providing user authentication and identity management in a network environment, such as the Internet.

II. Description of the Related Art

The Internet is a global network that is used by millions of people worldwide. The Internet can be thought of as a “network of networks” that links computers and users together through a set of network protocols, commonly known as Transmission Control Protocol/Internet Protocol (TCP/IP). According to these protocols, computers connected to the Internet are assigned IP addresses, which for convenience are also identified by domain names. These domain names are referred to in Uniform Resource Locators (URLs) through which files or pages are identified on the World Wide Web.

A Web site is typically defined as a set of network addresses on the World Wide Web under a single, second level domain name. Domain name servers exist to translate requests for network access to a URL by an Internet client or user into the corresponding IP address. Access to Web pages is normally carried out through a browser on the user's computer. A browser enables a user to enter a URL and, when the browser is given the submit command, to retrieve the corresponding file or page from the appropriate server on the Internet. The user's computer may be connected to the Internet through the server of an Internet access provider, which may include a proxy server that stores frequently accessed web pages to permit faster retrieval by the user's computer.

Web pages are written in HyperText Markup Language (HTML), and transmitted across the Internet by means of HyperText Transfer Protocol (HTTP). Resources in a network environment are often protected by passwords, and resources on the Internet are no exception. For example, a Web site may simply wish to identify those who access it for informational purposes or for commercial purposes. Other Web sites may simply be private or may only be accessible by payment of a fee, in which case user identification is required for billing purposes. Typically, restricted Web resources identify users by combination of a username and password. The username is generally a name or word known openly, and is used for identifying the user. In contrast, the password is some other word or phrase or combination of symbols that is known only to the server administering the resource and to the user. When the password submitted by the user matches the password stored against the username, access to the restricted resource is permitted by the resource-administering server.

In order to obtain access to a restricted resource (such as a restricted Web site), it is necessary for a prospective user to go through an enrollment or registration procedure. During registration, a convenient username is recorded against the necessary details of the user, such as name, address and account number. The user then enters a secret password which is recorded by the resource server against the username. On subsequent visits to the restricted Web site, the user will only be required to complete an authentication procedure to gain access. On the World Wide Web, an authentication procedure typically involves an HTML logon form through which at least the username and password are submitted to the administering server. Once access has been provided in a browser session, further requests for data from the restricted resource can be assured by the use of known procedures, such as Basic Authentication or the use of persistent client state objects (commonly referred to as “cookies”).

In most network environments, including the Internet, restricted resources can also exist that do not require a pre-arranged password and/or that do not require any password at all (i.e., restricted resources that only require a username and logon procedure). As will be readily apparent from the detailed disclosure provided herein, access to these types of restricted resources are considered to be within the purview of the present invention. For these types of restricted resources, a simple registration procedure with an acceptable username may be all that is required to control access.

Modern Web browsers typically include features such as bookmarks, favorites, or hotlists. These can take the form of a file or hypertext page, with links to destination URLs that have been deliberately selected and stored by the user. By controlling a mouse and clicking on a name, button or link in one of these catalogs or lists, a user can cause the browser to fetch the appropriate page from the Internet and display it for viewing on their computer. If the page is a restricted resource that requires user authentication, then the user (if previously registered with the site) will be required to use an access or authentication procedure to gain access. During the course of the authentication procedure, the user will be required to provide the correct username and password.

Due to the increasing number of resources that are available on the Internet, a user may have different passwords for different resources. The user may also have different usernames for each resource. Although this is beneficial for security reasons, the user is burdened with the task of remembering or recording (even though this is a poor security practice) all of their unique username and password combinations. In most cases, a user will record their unique username and password combinations in their browser or elsewhere on their computer. This practice, although convenient to the user, can result in a security breach of the user's password(s) and/or cause unauthorized access to restricted resources of the user.

Software is available to store user names and passwords securely on a user's a computer. However, this approach may not be convenient or practical if the user needs to access the network from more than one computer. Furthermore, in the event of failure of the user's computer or data loss (e.g., due to a computer virus or user error), the user may lose all of their user names and passwords.

Another drawback of accessing independent restricted resources is the need to repeatedly perform authentication procedures during a browser session. That is, because separate authentication procedures are required for each restricted resource, a user will be required to repeatedly enter their unique combinations of password and username to gain access to the resources during a browser session. Therefore, not only is the user required to provide the correct password and username combination for each resource, but also the user is burdened with performing several authentication procedures throughout a browser session. This is often time consuming and, in some cases, may discourage browsing of restricted resources.

In addition to the above-noted drawbacks, users of the Internet also have a difficult time managing their identity and access to restricted resources. For example, if a user needs to correct certain user profile or registration data (such as the user's name, address, telephone number, credit card number, etc.), then the user must perform a registration update at each resource. A user is also required to go through this time consuming task if a change to the user's username and/or password is required due to, for example, a security breach of this information. As a result, there is a need for an improved process or technique for permitting user's to manage their identification information on the Internet.

### SUMMARY OF THE INVENTION

To address the above-noted drawbacks, the advantages and purposes of the invention will be set forth in part in the description which follows and in part will be obvious from the following description. The advantages and purposes of the invention will be realized and attained by means of the elements and combinations particularly pointed out in the appended claims, or may be learned by practice of the invention.

To attain the advantages and purposes of the invention, as embodied and broadly described herein, the present invention provides a logon server on a distributed client/server network environment, such as the Internet, for simplifying user logon procedures and providing identity management.

The logon server of the present invention is used to implement a Web-based service that provides a centralized repository of user profile data. Through the various features and aspects of the invention, a list of favorite destinations can be stored in a library of user specific and general resource data. The list of favorite destinations can be selectively displayed to the user as a catalog of selectable resources. The logon server may also be implemented to provide a mechanism for Web based single sign-on to sites that require entry of a username or password (or any other user specific information for authentication).

In accordance with an aspect of the invention, there is provided a distributed client/server computer system comprising a network of servers and clients in which user access to restricted resources is controlled by a logon procedure that identifies an authorized user to a respective administering server. The system preferably includes a logon server accessible by a plurality of clients, wherein the logon server is provided with:
a) a user authentication procedure by means of which a user can logon to the logon server from one of the plurality of clients and use the authentication procedure to uniquely identify that user to the logon server;
b) a stored library, specific to a registered user of the logon server, that comprises network addresses of user-selected resources, including restricted resources, and user data to satisfy logon procedures for the user to access restricted resources; and
c) means for detecting a request from a user logged-in through one of the clients for access to data from a resource and for carrying out at least one of the following procedures in the case of a detected request for access to a restricted resource:
   (i) using the stored library of user data to complete a user logon procedure for that resource to log the user on to the resource, receiving the requested data from the server administering the resource, and forwarding the data to the client by which it was requested;
   (ii) using the stored library of user data to prepare a user logon form for that resource on behalf of the user and forwarding the form to the client to log the user on to that resource; or
   (iii) using the stored library of user data to partially complete a user logon form for that resource on behalf of the user, serving the partially completed form to the client, receiving the form from the client after the insertion of data by the user, and adding data inserted into the form by the user to the library for recall for future use in procedure (i) or (ii).

The user logon procedure will typically be a user registration procedure or, on subsequent visits by the user to the resource, a user authentication procedure. Likewise the user logon form will typically be a user registration form or, on subsequent visits by the user to the resource, a user authentication form.

Preferably, in systems consistent with the principles of the invention, the logon server authentication procedure includes transferring a username from the client to identify the user and transferring a verification from the client to verify the user, wherein the verification is an action specific to that username. A particularly preferred action is a demonstration of the recognition of a specific set of complex images, such as a set of human faces. The security benefits of such a system, and methods of implementing such a system, are described in U.S. Pat. No. 5,608,387, the disclosures of which is expressly incorporated herein by reference in its entirety. The logon server may also be provided with means for requesting access to the data from the server administering the resource, in order to determine whether the resource is a restricted resource. The requesting means of the logon server may comprise means for searching for an HTML form in order to determine whether the resource is a restricted resource.

The means for carrying out the above-noted procedures (i), (ii) and (iii) may include a store of user logon forms for restricted resources.

The stored library may include a user-editable catalog of resources and the logon server may be provided with means for displaying the catalog to the user for enabling the user to select a resource to log on to for access. Such a catalog may be specific to the user. Desirably, selection of a resource from the catalog by the user is interpreted by the logon server as a request for access to data from that resource. The catalog, accordingly, may serve as a bookmark or favorites destination file that can be accessed by the user irrespective of the client that they are using at any time.

In accordance with a further aspect of the invention, there is provided a method of logging a user on a to user-selected restricted resource from one of a plurality of client locations in a distributed client/server computer system. The distributed client/server system may comprise a network of servers and clients, in which user access to certain restricted resources is administered by at least some of the servers and controlled by a logon procedure that identifies an authorized user to the respective administering server. Preferably, the method of logging a user on to a restricted resource comprises:
a) providing a logon server in the network;
b) transmitting a user request from one of the clients to the logon server to log the user on to the server;
c) invoking a user authentication procedure by which a user can log on to the logon server from one of the plurality of clients and use the authentication procedure to uniquely identify that user to the logon server;
d) maintaining a stored library, specific to a user of the logon server, that comprises network addresses of user-selected resources, including restricted resources, and user data to satisfy logon procedures for the user to access the restricted resources;
e) detecting a request from a user logged-in through a given client for access to data from a resource, and, in the response to a detected request to access a restricted resource, carrying out at least one of the following procedures:
   (i) using the stored library of user data to complete a user logon procedure for that resource to log the user on to the resource, receiving the requested data from the server administering the resource, and forwarding the data to the client by which it was requested;
   (ii) using the stored library of user data to prepare a user logon form for that resource on behalf of the user and forwarding the form to the client to log the user on to that resource; or
   (iii) using the stored library of user data to partially complete a user logon form for that resource on behalf of the user, serving the partially completed form to the client, receiving the form from the client after the insertion of data by the user, and adding data inserted into the form by the user to the library for recall for future use in procedure (i) or (ii).

The above-indicated steps may be used in combination with a method for authenticating a client to a server in a distributed client/server computer system. The system preferably comprises a network of servers and clients in which user access to certain restricted resources, administered by at least some of the servers, is controlled by a logon procedure that identifies an authorized user to the respective administering server.

The user data from the library may be used in order to log the user on to a resource (not previously accessed by the user) through the logon server if the resource requests data that is already held for that user in the library.

The user may be authenticated in subsequent visits to a restricted resource by the logon server serving a completed input or logon form, either direct to the resource or to the client for the client to submit to the resource.

The following description provides an overview of how the various features and aspects of the invention may be implemented. It is to be understood that this description is exemplary and for purposes of illustration and rather than limitation.

First, a user logs on to the logon server from any client computer on the distributed client/server network. The user can log on to the server using an authentication procedure previously established for that user. When the user adds a new URL to their logon server destinations, the logon server checks the corresponding web page to see if that page requests information from the user. If it does, then the logon server displays the page to the user for them to fill in. The logon server captures the details that the user fills in and replays this information to the site when the user returns to that site via the logon server. In this manner, the logon server provides the user with a single sign-on service to their favorite Web destinations. Also, since all of the user's destination and single sign-on information is stored centrally on the logon server database, the user gains mobility and can use their destinations, usernames, passwords, etc. from any computer with Web access.

The logon server of the present invention may also be implemented to list a number of “top sites” which can be automatically transferred to the user's destinations (without the user having to enter the URLs). For these sites, an automatic registration feature can be offered to the user. If the user clicks on this option, the site's registration form is displayed and the logon server captures the user's registration information (e.g., name, address, username, password and/or other demographic information). The logon server can use this captured information to automatically “fill in” registration forms for other sites. In this manner, the invention accelerates the user's path to registering and logging on to their favorite sites. Also, the more Web services the user registers for via the logon server, the more information the logon server gathers and enrollment to other web services becomes more automated.

The aforementioned and other features of the invention will become more apparent from the following detailed description. It is to be understood that both the foregoing general description and the following detailed description are exemplary and explanatory only and are not restrictive of the invention, as claimed herein.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings,

FIG. 1 illustrates an exemplary network environment in which the features and aspects of the present invention can be implemented;

FIG. 2 illustrates, in accordance with another aspect of the invention, a distributed client/server network that includes a communications network in the form of the Internet;

FIGS. 3A and 3B are exemplary flowcharts that illustrate general features and aspects of the invention;

FIG. 4 is an exemplary flowchart of the single sign-on procedures of the present invention;

FIG. 5 is an exemplary flowchart that illustrates the various processes and operations for performing automated registration, in accordance with the principles of the invention;

FIG. 6 is an exemplary diagram illustrating the various features and aspects of the invention for permitting a registered UAIM user to log on to a site;

FIG. 7 is an exemplary diagram illustrating the various features and aspects of the invention for permitting a registered UAIM user to sign up to a site;

FIG. 8 is an exemplary diagram illustrating the various features and aspects of the invention for permitting a non-registered UAIM user to enroll and sign up to a site;

FIG. 9 is an exemplary diagram illustrating the various features and aspects of the invention for permitting a non-registered UAIM user to enroll and convert their existing account to UAIM;

FIG. 10 is an exemplary diagram illustrating the various features and aspects for of the invention for permitting a registered UAIM user to convert their existing site account to UAIM;

FIGS. 11A and 11B, in accordance with an additional aspect of the invention, illustrate exemplary User Card forms for collecting user information during a user enrollment procedure; and

FIG. 12 illustrates an example of a screen display at a client's computer for implementing an authentication procedure using complex images.

### DESCRIPTION OF THE PREFERRED EMBODIMENTS

Reference will now be made in detail to the present preferred embodiments of the invention, examples of which are illustrated in the accompanying drawings Wherever possible, the same reference numbers will be used throughout the drawings to refer to the same or like parts.

The following description will explain the invention in terms of a distributed client/server network, such as the Internet or an intranet. However, the invention is not so limited in principle and can be applied to any suitable network environment of distributed client and server computers.

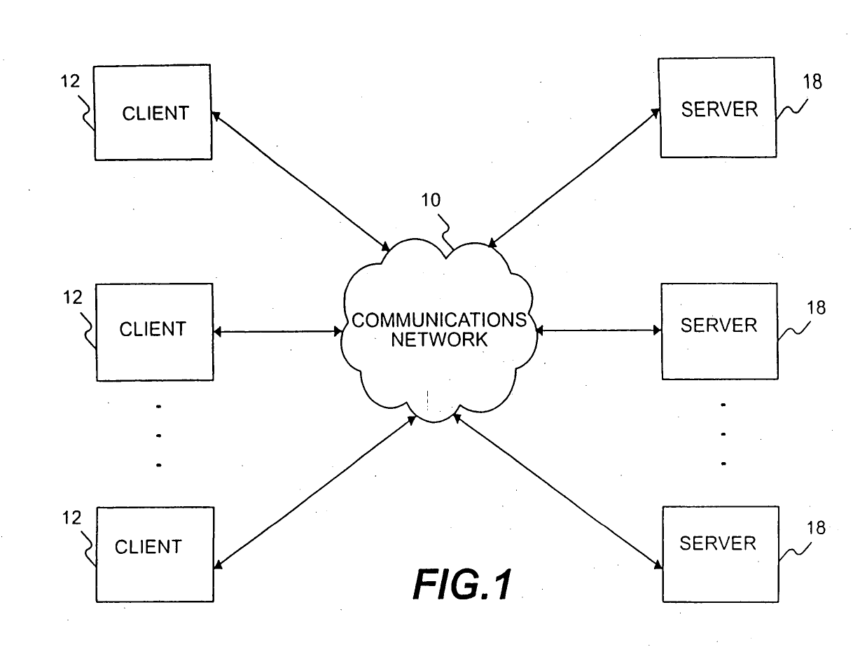

FIG. 1 illustrates an exemplary distributed client/server network in which the features and aspects of the present invention can be applied. As shown in FIG. 1, the distributed client/server network includes a plurality of clients 12 that communicate over a communications network 10 with a plurality of servers 18. Each of the clients 12 may comprise a computer system for communicating over a telephone line, digital subscriber line (DSL), cable or other communications link with network 10. Communications network 10 may comprise a local area network (LAN) or private network (such as an intranet), or may be a global communications network (such as the Internet). Servers 18 may include generally accessible or restricted resources. These resources may be informational or commercial resources, and may be implemented through Web sites or pages.

In accordance with the features of the invention, one or more of the servers 18 in FIG. 1 may also be implemented as a logon server. As further described herein, a logon server according to the present invention can facilitate registration and authentication of users located at clients 12 who seek access to resources provided through one or more servers 18. Each logon server may also include a centralized repository for user specific or general resource data. This data is used by the logon server to perform various functions, such as single sign-on and automated registration in the distributed client/server network. For this purpose, servers 18 may further include a database (not shown) for storing user specific and general data.

The functionality provided by the logon server requires that each user register with the logon server. This is necessary in order to collect pertinent user data (e.g., name, address, telephone number, credit card data, etc.) and authentication data (e.g., username and password combination or other authentication data) that is unique to the user. Once a user is registered with the logon server, then a single sign-on or logon with the logon server will permit the user to visit and access various resources on the network with little or no interference from resource specific authentication procedures. This is because the logon server will automatically perform the authentication procedure that is required for each site on behalf the user. Through the logon server, registered users can also easily update and manage their identification information for accessing resources on the network. These and other aspects of the invention will be further described in the detailed description that follows.

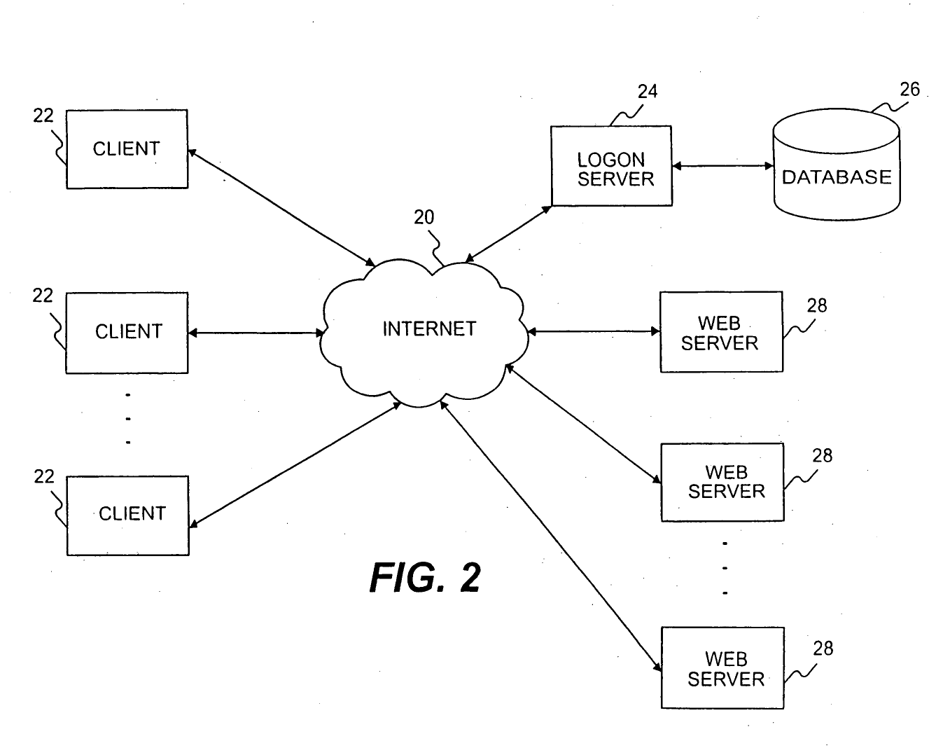

In order to facilitate an understanding of the various aspects of the invention, an exemplary embodiment of the distributed client/server network will be described with reference to the Internet. FIG. 2 illustrates a distributed client/server network that includes a communications network in the form of the Internet 20. Connected to the Internet 20 are various clients 22 and Web-based servers 28. Also connected to the Internet 20 is a logon server 24 that includes a database 26. Database 26 stores data for each of the registered users of logon server 24. Registers users connect to the Internet 20 via clients 22 in order to access one or more resources provided through Web servers 28. Web servers 28 communicate with logon server 24 to authenticate registered users and gather user specific information or profile data, as further described below.

In an exemplary distributed client/server computer network system of FIG. 2, users at clients 22 access the Internet 20 in any known way using, for example, client computers to identify themselves to logon server 24. When a registered user logons to logon server 24, the user will be required to authenticate themselves by taking an action that verifies their identity. For this purpose, a logon procedure may be executed by logon server 24 to prompt the user to enter or verify their authentication data. This may take the form of prompting the user to enter a unique username and password combination or some other form of authentication data. For example, registered users may be prompted to enter or confirm their username along with a unique set of complex images, such as a set of human faces. A system and method for implementing such an authentication procedure is disclosed in U.S. Pat. No. 5,608,387.

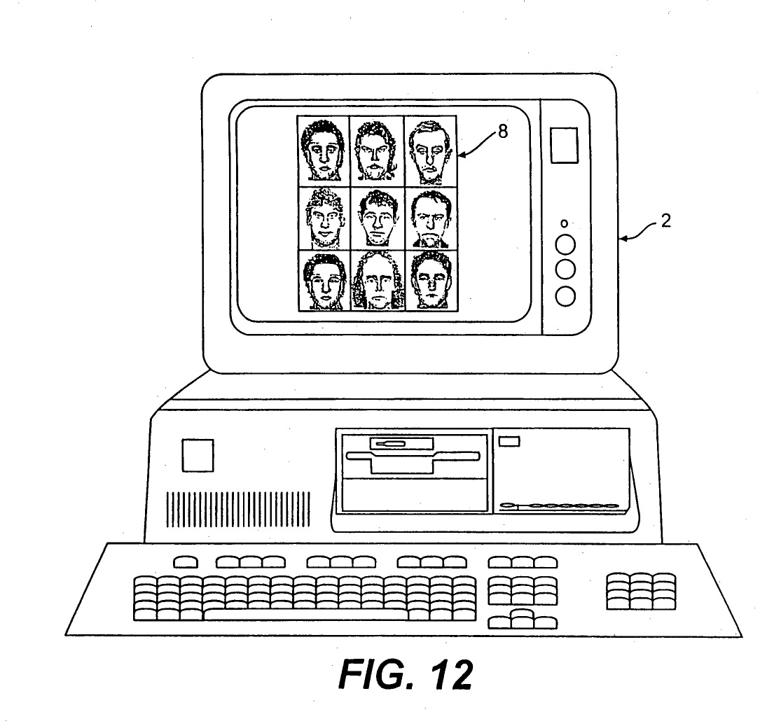

If complex images are used for authentication, then one or more sequences of screen displays may be presented to a user to authenticate their identity through correct image selection. Each screen display may comprise a matrix of images (e.g., a 3×3 matrix) in which one key or true image is displayed with other dummy or decoy images. In order to be authenticated, the user is required to select the key image over the dummy images from each matrix. This process may be repeated over several screen displays (e.g., four or five screens) so that the user selects all of their unique key images for authentication. For purposes of illustration, FIG. 12 is representation of a client's computer 2 with one of a sequence of screen displays in which a respective one of several key images is displayed with eight dummy images arranged in a matrix 8.

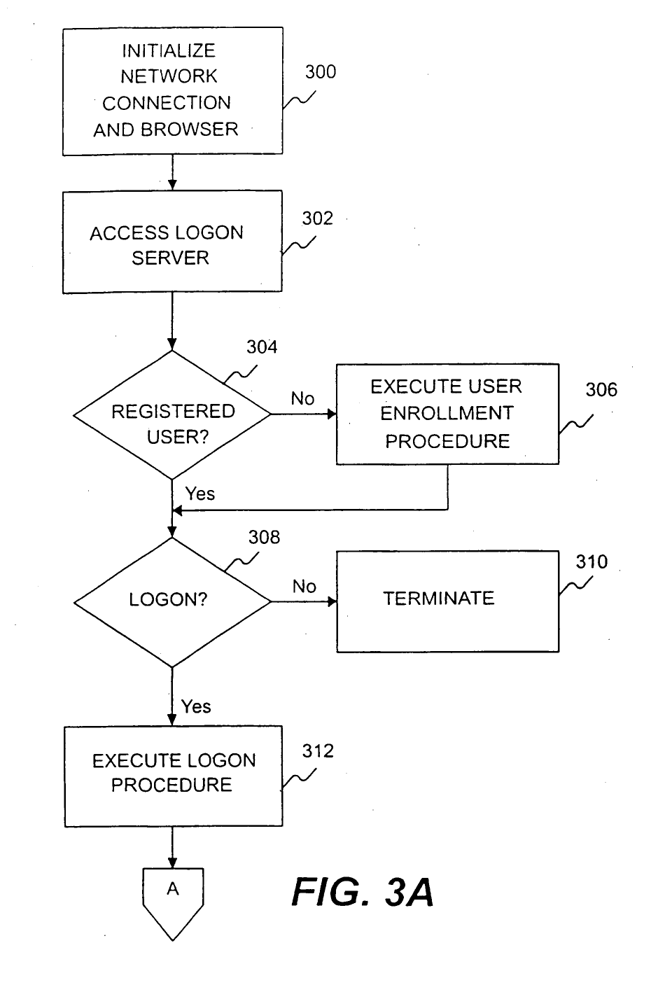

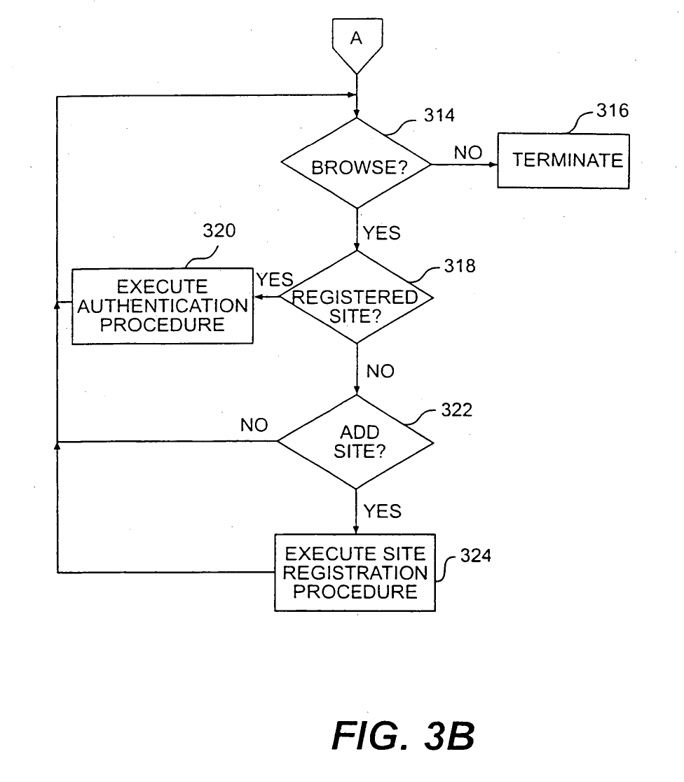

Referring now to FIGS. 3A and 3B, a more detailed description of the features and aspects of the invention will be presented. As indicated above, the logon server of the present invention facilitates user authentication and identity management in a distributed client/server network, such as the Internet. At the logon server, a user can register or enroll to become a registered user of the logon server. Once a user is registered, the user can perform a single logon to authenticate their identity and effectively activate automated authentication through the logon server to gain access to restricted resources. In other words, once a registered user has logged on to the logon server, the logon server will automatically authenticate the user to restricted resources. However, in order to automatically authenticate a user, the resource must be enabled or registered with the logon server. This is necessary to enable the logon server to locate and determine the information required by the site for registration and subsequent logon by the user. Enabled or registered resources are preferably indexed in a general access list (to facilitate features such as automated registration, described below) or in the user's catalog of preferred or favorite destinations (to facilitate browsing by the user).

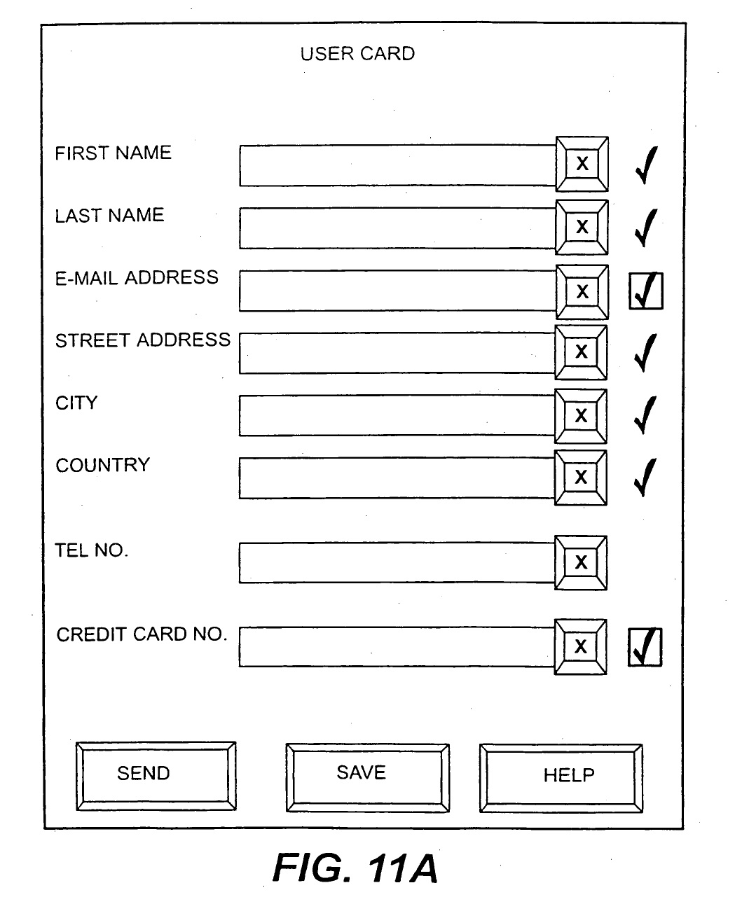

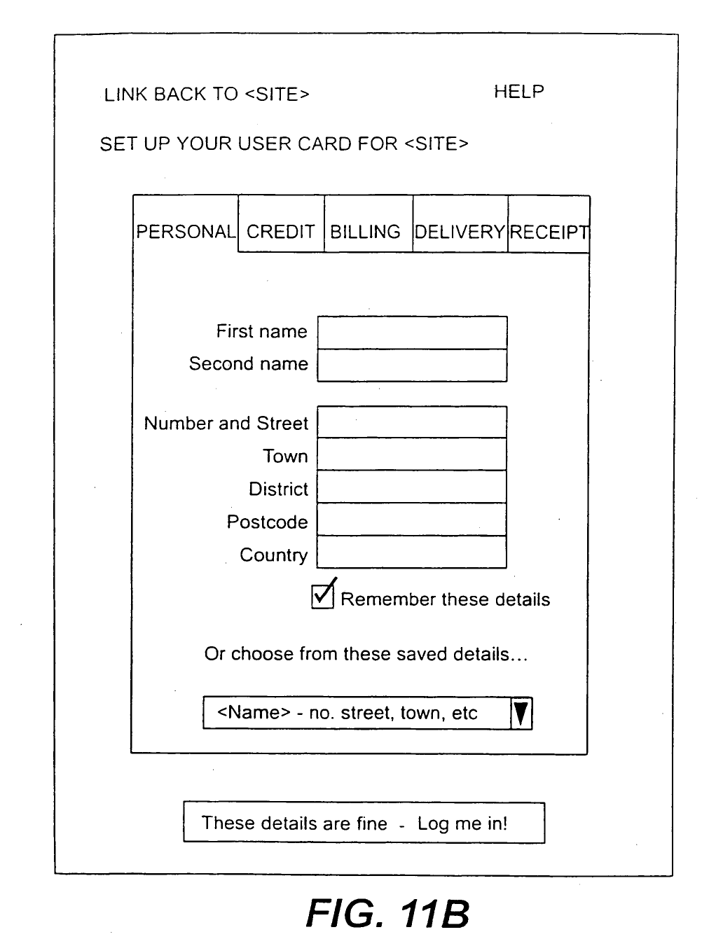

In particular, as illustrated in FIG. 3A, a user firsts initializes their network connection and browser (step 300). If, for example, the user is located at one of the clients 22 in the embodiment of FIG. 2, the user may simply initialize their client computer system (including hardware and software) and access the Internet 20 through conventional means, such as an Internet service provider. Once connected to the network, the user may control their browser to access a designated or predetermined logon server (step 302). A Web page of the logon server may then prompt the user to enter a user name in order to determine whether the user is registered with the logon server (step 304). If the user is not registered and requests to enroll, then the logon server may execute a user enrollment procedure to register the user (step 306). As indicated above, during the registration process, the user may be prompted by the logon server to gather pertinent user data (e.g., name, address, telephone number, credit card data, etc.) and authentication data (e.g., username and password combination or other authentication data). This process may be used by the logon server to set-up a unique file or record for the user and facilitate future user authentication and identity management. As further disclosed herein (see, e.g., FIGS. 11A and 11B), a simple and uniform enrollment form may be displayed to the user to gather information and create a unique card or record for the user.

For users that are registered with the logon server, a prompt may be provided to determine if the user wishes to logon (step 308). If the user decides to logon at a later time or closes the current session, then the process terminates or is suspended until the user again accesses the logon server (step 310). If, however, the user requests to log on, then the logon server executes a logon procedure to authenticate the user (step 312). During this phase, the logon server will log and authenticate the user against their unique authentication data (e.g., username and password). If the user successfully logs on, then the user may further browse Web pages of the logon server or attempt to access resources on the Internet, including restricted resources (FIG. 3B, step 314). If, however, the user is not able to authenticate its identity after a predetermined number of attempts (e.g., three attempts), then the logon server may terminate the logon procedure and/or further block attempts to logon until after a predetermined period (step not shown in the figures).

As illustrated in FIG. 3B, if the user decides to stop browsing and closes the current session, the process may terminate (step 316). If, however, the user browses after logging on, then the user may attempt to access resources over the Internet. When a user attempts to access a restricted resource that is registered (Yes; step 318), then the logon server will execute an automated authentication procedure to authenticate the user to the site (step 320). As further described below, the authentication procedure may be performed by the logon server in response to a query from the resource to which access was requested by the user. Since the resource is registered with the logon server, the logon server will be able to automatically authenticate the user without any involvement from the user. As a result, the user can freely browse the site and attempt to access other resources without the need to manually enter any authentication data.

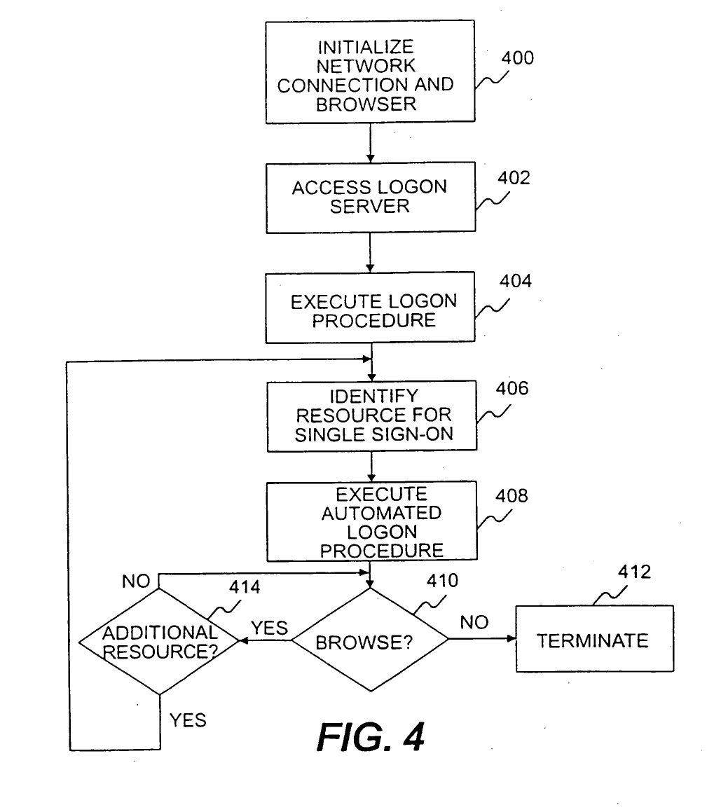

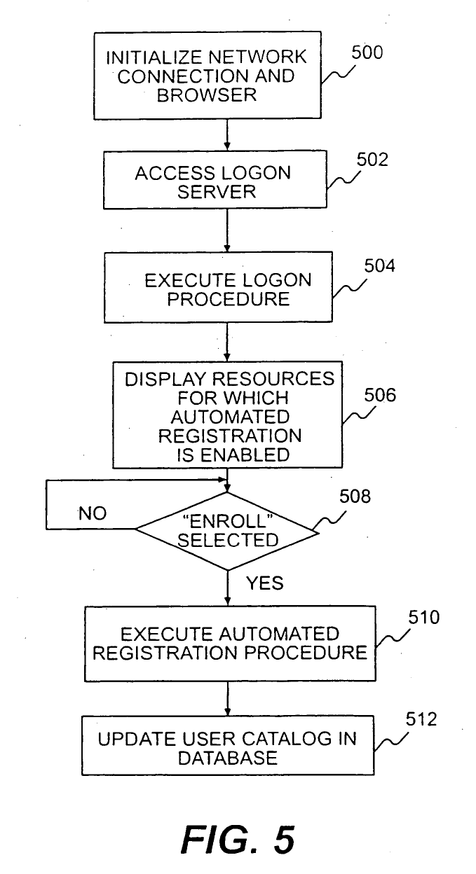

For sites contacted by the user that are determined to be non-registered resources (No; step 318), such sites will need to be added to permit automated authentication in the future. Before a site is registered with the logon server, the user may be prompted to determine if the site should be added (step 322). If the user indicates not to add the site (No; step 322), then the user can, for example, perform a manual registration with the site and continue browsing. If, however, the user decides that the site should be added and included in their catalog of destinations (Yes; step 322), then the logon server will execute a site registration procedure to enable or register the site (step 324). The manner in which sites can be registered is further discussed below with reference to, for example, FIGS. 4 and 5. After the site is registered, the logon server will update the user's file or record to add, for example, the resource to the user's list of favorite destinations. Thereafter, the user can continue browsing and attempt to access other resources, as discussed above.

Referring again to FIG. 2, after a successful logon with the logon server, the user may select or access various resources on servers 28, including restricted resources. There are a number of ways in which the features of the invention can be used in this regard. For instance, a user at one of the clients 22 can use a single sign-on procedure to add to new resources (i.e., Web sites) to their list of destinations. This can be performed by directly selecting the resources that they want to add through their browser. Alternatively, a user can invoke an automated registration procedure to add sites specifically offered by the logon server 24. In each case, there is an initial site registration phase, followed by simple user authentication procedure on subsequent visits to the same site. The single sign-on and automated registration procedures of the present invention are further described below with reference to FIGS. 4 and 5.

As described above, registered users of the logon server may be prompted to enter or confirm their username along with a unique set of complex images, such as a set of human faces. In such a case, the logon server can be implemented, in accordance with an additional aspect of the invention, to assign a user's key images to provide a consistent level of authentication assurance. Unlike a password based authentication system, where the user is allowed to choose their password, the logon server may be implemented to not allow the user to choose their key images. This avoids one of the major problems of password based access control; that is, the user secret is predictable, especially if a hacker has knowledge of the user's personality.

In traditional password based authentication systems, the most effective attack is to iterate though a dictionary of commonly used words or phrases, giving special bias to words or names that have special relevance to the user. In the authentication system of the present invention, if the user is allowed to choose their key images, an analogous attack could be performed. For example, an unauthorized user could try to logon by identifying the faces that, from knowledge of the user's personality, ethnicity or environment, could be predicted as being the most familiar or attractive to that user.

The logon server of the present invention can avoid these types of attacks by randomly assigning the key images to each user. In a password based system, such an approach would be unusable and/or insecure, since the user could not be expected to remember a randomly generated password and, therefore, would have to write it down in order to use the system reliably. The logon server avoids this issue by exploiting the user's natural ability to recognize complex images, such as human faces, irrespective of whether the user has chosen the faces to be recognized.

By assigning the key images to the user at random, the invention provides an authentication system that has a known, consistent level of accuracy that is not compromised by the inability of users to choose and maintain adequate secrets. Also, this aspect of the invention ensures that the user secret (knowledge of their key images) is only valid or authorized user of the logon server. In a password-based authentication system, users must be trusted to keep their password secret. Even if users are not allowed to choose their password at a site, they will be tempted to use the same password at other sites where they are allowed to choose their password. Consequently, other sites may be party to users' (system assigned) passwords. In contrast, use of complex images for authentication, with system assigned key images (such as a set of “key” human faces) prevents the user from sharing authentication data, since no other site will be allowed to use the same set of key images. Consequently, the user will not have the ability or incentive to use their authentication data for any purpose other than authenticating at the logon server of the present invention. This feature significantly reduces the risk of exposure of the user secret thereby increasing the level of assurance that the authentication that the logon server provides.

Referring now to FIG. 4, the single sign-on features of the invention will be described. The term “single sign-on” is used herein to mean a service offered by the logon server by which an authorized user (i.e., a user registered with the logon server) can make only one single sign-on in a browser session to access any of the restricted resources listed in the user's catalog. That single sign-on is the user's sign-on or logon to the logon server itself, during which the user is authenticated by the logon server. After the single sign-on is performed by the user, signing or logging on to cataloged resources, including username and password submission, is handled automatically by the logon server. As a result, the user can access restricted resources without the need to manually enter authentication data, since authentication to each restricted resource will be handled automatically by the logon server.

As a result, in order to access single sign-on, a user must first initialize their network connection and browser (step 400) and access the logon server through entering the appropriate URL address (step 402). The user must then perform their single sign-on or logon with the server. As such, when the user connects to the logon server, a logon procedure may be executed by the logon server (step 404) in response to the user clicking a “sign-on” button or simply entering their username. During the logon procedure, the user will be prompted by the logon server to provide their authentication data (e.g., username and password).

After the user is authenticated by the logon server, the user can select a resource from their stored catalog of destinations (step 406). Preferably, these sites are pre-registered or enabled for single sign-on through the logon server. This is necessary so that the logon server can store the appropriate network address and form data to perform an automated logon to the resource with little or no intervention from the authorized user. The selection of a resource from the user's catalog may be performed by simply clicking a button (such as a “logon” button) next to the listed resource. When a resource is selected by the user, the logon server will execute an automated logon procedure (step 408) to log the user onto the site based on the logon form data stored in the user's library.

As further illustrated in FIG. 4, the user may freely browse the restricted resource after being logged in by the logon server (step 410) or terminate the current browser session after accessing the resource (step 412). If the user decides to access other resources through single sign-on (Yes; step 414), then the user may return to the logon server to identify another resource on the user's catalog (step 406). Thereafter, automated logon for the selected site may be performed by the logon server in a similar fashion to previously selected sites. This process may continue so long as the current browser session with the logon server is maintained by the user. Otherwise, the user will be required to sign-on with the logon server before activating single sign-on with any restricted resource.

It is preferable that the sites on the user's catalog be pre-registered or enabled for single sign-on through the logon server. This is necessary so that the logon server can store the appropriate network address and form data to perform an automated logon to the resource without intervention from the authorized user. As such, the single sign-on procedure of FIG. 4 may include an initial procedure whereby sites are identified and added to the user's list of destinations. By way of a non-limiting example, the following description concerns a process by which new resources are added to the user's catalog.

An authorized user may enter the network address (conveniently, as the URL) of the restricted resource that they wish to add to their catalog of destinations. The network address may be entered or identified by the user through various means, including entry directly through the user's browser. When the network address is received by the logon server, the corresponding page for the resource is read by the logon server through, for example, its proxy server. Using procedures that will be understood by those skilled in the art, the logon server may be adapted to search for an HTML form within that page. If the logon server finds the HTML form, the user is offered a check box to confirm and enable single sign-on for that resource.

If the user chooses to use single sign-on, the logon server preferably rewrites the HTML of the page requested by the user to ensure one or more of the following:
All HREFS are removed so that no links can be followed off the page;
All image tags are rewritten to ensure that their URLs are absolute and so will be resolved correctly;
The form action is rewritten to submit the request to the logon server so that the logon server will receive the input from this form;
The original form action is added to the form as a hidden input field so that the logon server can record where the form contents should be sent in order to achieve single sign-on; and/or
Any input buttons are removed or converted into a single submit button (if there is not already an explicit “type=submit” on the page). This ensures that there is only one exit from the form and that it takes the user back to the logon server.

This rewritten page is then served to the user within a frameset that makes it clear to the user that the data that they are entering will be submitted to the logon server.

When the user enters the form, the logon server will receive the form data and store it for the user in a library, specific to that user. This library preferably contains the network address of the resource, as well as the form data to satisfy the log-on procedures for the resource. The library also stores a catalog of those resources that the user has chosen to include, which can be selectively displayed to the user, in the manner of a favorites or hotlist.

As indicated above, when an authorized user views their catalog of destinations within the logon server, sites can be selectively identified by the user for single sign-on. When a restricted resource is selected by the user, the logon server can serve the user a page that contains their destinations' input forms with all of the form contents as hidden fields. Clicking on, for example, the “Go” button for that destination will effect single sign-on to the site (as the form action no longer sends the data to the logon server, but to the URL contained in the original form action). In this way, the user only needs to carry out one single manual sign-on procedure to access the logon server, after which the logon server handles automatically the subsequent logons to restricted sites in the user's catalog.

An additional complication, which requires the above-described single sign-on procedure of FIG. 4 to be modified, is when the form to be entered is contained with an HTML frameset. To find this form, the logon server needs to recursively search the frameset. Once it has found the frame containing a form, the logon server will serve the frameset to the user with all frame references and image references rewritten to be absolute so that they are sourced from the original site and with all HREFs removed. In effect, HREFs are HTML links to other URLs. Within this frameset, each frame reference on route to the frame that contains the form is rewritten by the logon server. This is performed so that each frame reference will be sourced from the logon server, which will have cached these pages under their URLs. The frame containing the form will be sourced from the logon server, which will rewrite it as described above.

Consequently, as in the above-described example without frames, the user sees a composite page that looks almost identical to the logon page of the original site. The only differences are that the form data will be sent to the logon server and that there is an additional logon server frame to remind the user of this fact.

When the user clicks on the ‘Go’ button in their catalog next to a destination which involves a frameset, the logon server will read the top level page and all constituent frames which are on route to the frame containing the form through, for example, its proxy server. It will rewrite them as described above and serve them to the user, except that this time HREFs will be made absolute rather than removed. This time, however, instead of presenting the frame containing the form rewritten to send its data to the logon server, the form is rewritten to send the user's logon data to the original form action URL. The effect of this is that the logon server has filled in the form for the user. As a result, all the user has to do is press the submit button. Alternatively, in order to minimize user intervention, the action of the user pressing a submit button could be simulated using Javascript, if this can be handled by the user's browser.

Referring now to FIG. 5, the automated registration features of the present invention will be described. The automated registration features of the invention relate to an automated process for permitting a user to register or enroll with various, third party Web services. The automated registration process is implemented through the logon server of the invention and may be provided as a free service to authorized users. The third party Web services may themselves be free or offered to users on a discounted basis to encourage enrollment. In either case, a user is first required to logon to the logon server before electing automated registration.

Therefore, as shown in FIG. 5, a user that desires to enroll in a Web service through automated registration will first initialize their network connection and browser (step 500). The user will then access the logon server (step 502) by entering the appropriate URL, and authenticate themselves through logging or signing on with the logon server (504). After the user logs on with the logon server, the logon server will display a list of Web services for which automated registration is enabled (step 506). For each service in this list, the logon server will provide a brief textual description of what the service offers the logon server user. If the user clicks on an “Enroll” button for a particular service (Yes; step 508), the logon server will then execute an automated registration procedure to register the user with the service (step 510). After registration is completed, the user's catalog of destinations may be updated by the logon server (step 512) to include the newly registered site and facilitate future access (e.g., with single sign-on, etc.).

As part of the automated registration procedure of FIG. 5 (step 510), the logon server will fetch the registration form page for the third party site through, for example, its proxy server. The logon server will then rewrite the HTML for this page in a similar manner as for single sign-on. The logon server will have a template for this form that contains a mapping between the field name used on the form and the logon server's name for this information. If the logon server has already collected any of this information about the user in its library of user data (e.g., because the user has already used the automated enroll process), then it will fill in the data in the form from its database for that user according to the template. The page will then be served to the user with the form action rewritten (as for single sign-on), so that the form data will be sent to the logon server instead of the third party site's server.

The user then fills in any blank fields in the registration form and submits the form. The logon server receives the form data and, by reference to its template for this form, extracts the user's information which is stored in the logon server's library record for the user, using the logon server's field naming. Thereafter, the logon server submits the form to the third party site's server in order to effect registration. The logon server will receive from that site the result of the registration (which may contain an additional form). As before, the logon server will rewrite this page as necessary and serve it to the user.

In effect, the logon server is monitoring the user's registration process with the third party server. When enrollment is complete, this will be recognized by the logon server matching a particular response from the third party server or by the user clicking on a button on the logon server frame. The logon server then creates a new “destination” for the user with the name of their choice. For many destinations, the logon server will know how to fill out the logon form for the site with the user's information gathered during the registration process by reference to another logon server template corresponding to the site's log on page. For some services, especially those that allocate a username or password to the user and send it to them via email, the logon server may need the user to teach it to log on to that service before single sign-on can be enabled. If this is the case, then the mechanism for single sign-on (as described above with reference to FIG. 4) will be used to collect and store the log-on form data from the user.

As described in detail above, the logon server of the present invention permits a user to find out about, enroll for and use as many Web services as they wish, without ever needing to remember the authentication data (such as usernames or passwords) for each service. The features of the invention, therefore, overcome the above-noted drawbacks and provide an improved method and system for user authentication in a distributed client/server network environment, such as the Internet.

Some sites use an HTTP protocol called Basic Authentication to authenticate their users. Where Basic Authentication is used, the logon server of the present invention can not collect user data using an HTML form. Instead, when the user attempts to access a page that requires authentication, the Web server will serve their browser an error including an HTTP header that requests authentication. Thus, some modification to the logon server or disclosed features may be required.

Modern web browsers respond to the error/header by prompting the user for a username and password. Subsequent requests to that server that the browser makes to a server-specified realm (all paths under a specified location on the server) will be accompanied by a header which provides the username and password information gathered from the user. Thus, the user only needs to enter this information once per browser session (or may even store that information in their browser), but the browser will submit it to the server for every page requested from the specified realm.

The logon server's single sign-on mechanism, as described above, will not work with this type of system. The logon server, however, can provide a number of features in order to facilitate the maintenance of usernames and passwords, especially when the user may be “mobile” or using more than one Web browser or more than one computer to access Web services.

These features can include:
A user “notes” field to accompany each destination. Users can store, in a secure and centralized manner, the usernames and passwords required for services that use basic authentication. The user would then simply copy the information from the notes that the logon server displays for a destination and paste it into the username and password dialog box that their browser displays;
The logon server can implement an additional proxy server that would modify the requests from the user's browser in order to include the basic authentication information that could be stored by the logon server. This effectively means that the logon server implements the user's browser's part of the basic authentication system on the user's behalf; and/or
The logon server can provide an optional downloadable component which, when installed, reads basic authentication information belonging to the user from the logon server. This component, now running on the user's client computer, can insert this information into the user's browser's password management system in order to “fool” the browser into using this information instead of prompting the user to enter it.

In accordance with an additional aspect of the invention, the logon server of the present invention may also be implemented with a range of administration functions that allow users to manage their logon server destinations. For example, various administration functions could be provided to permit users to delete, rename or edit the destinations in their personal catalogs of destinations. When deleting or editing their destinations, the logon server may be adapted to display the log-on form contents that the user originally entered. This allows the user to be reminded of their usernames and passwords should they wish to enter them manually or should they need to “re-teach” the logon server how to log on to a service that may have changed its logon form.

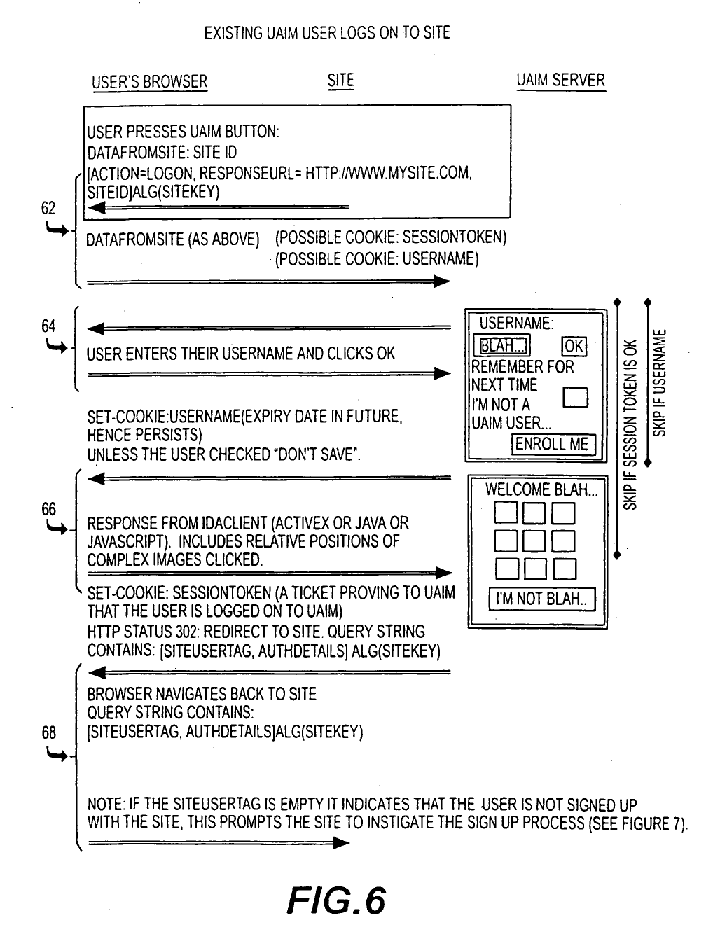

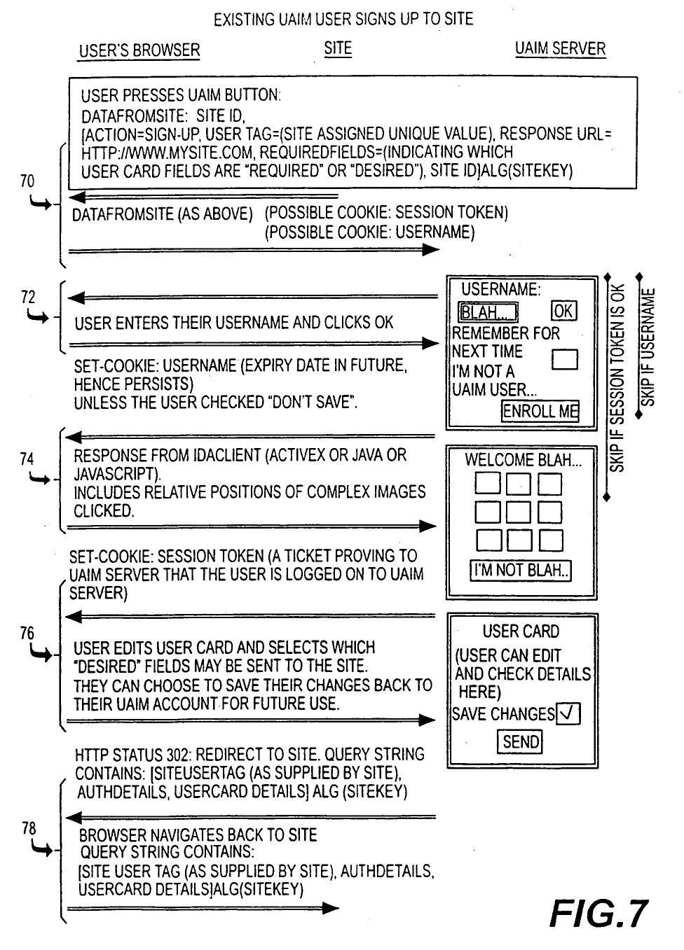

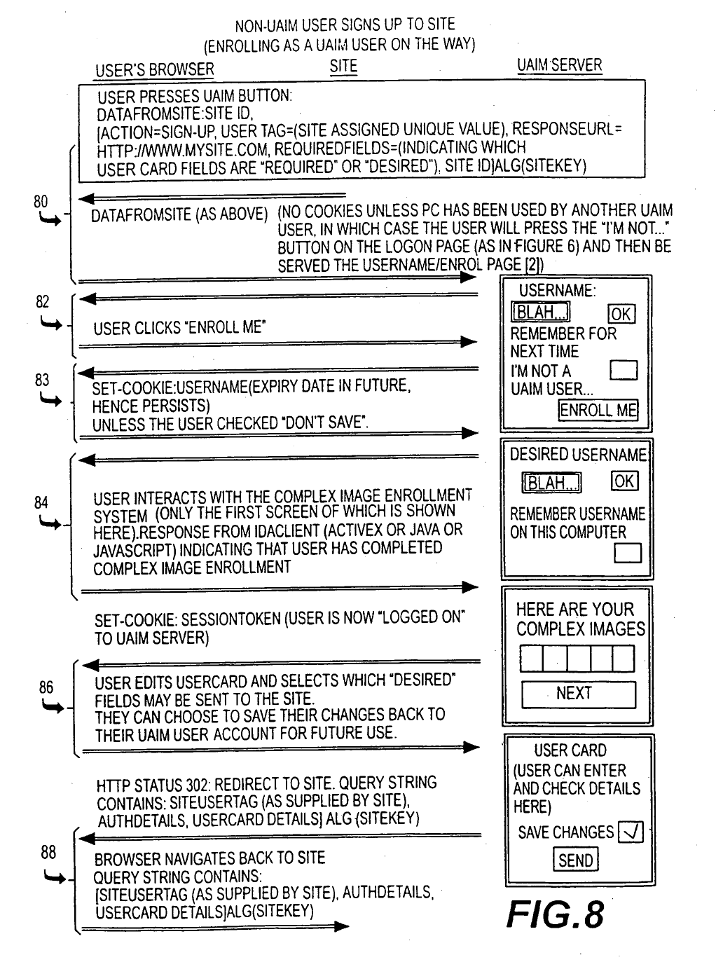

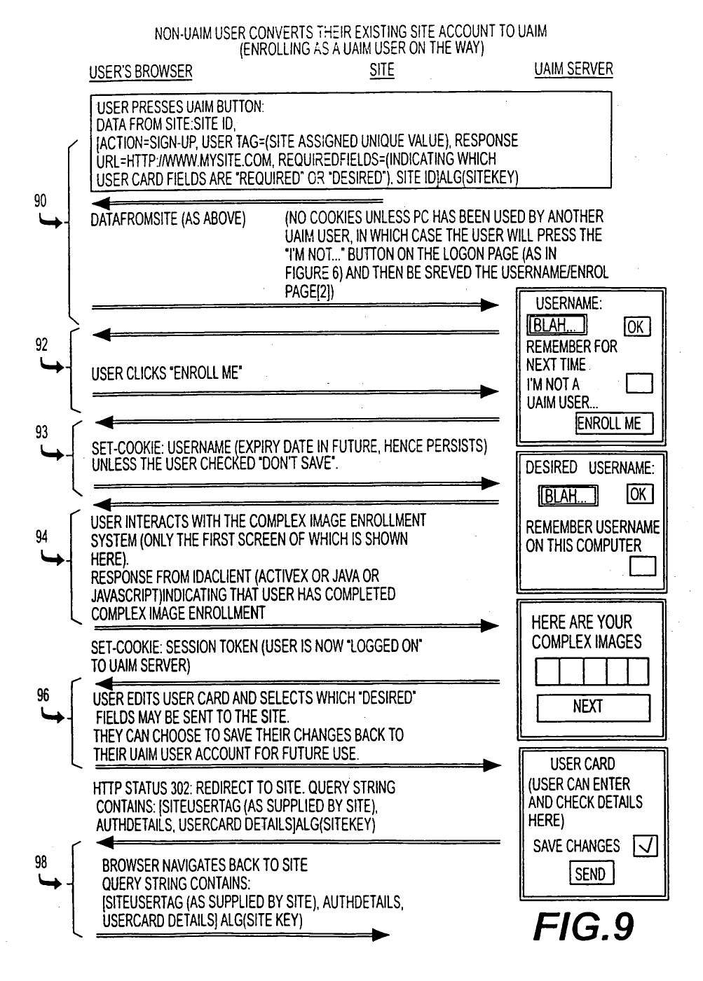

Referring now to FIGS. 6-11, the features and aspects of an enhanced logon server will be described. In accordance with the principles of the invention, an enhanced logon server is a logon server that is implemented both user authentication and identity management. For purposes of the following description, an enhanced logon server with the above-noted characteristics will be referred to as a UAIM (User Authentication and Identity Management) Server. In addition, in order to avoid any confusion regarding terminology, the following conventions will be used for the descriptions of FIGS. 6-11: a user can register or enroll with the UAIM Server and, after registration, will become an authorized, UAIM User; a UAIM User can logon or authenticate itself at the UAIM Server; and once a UAIM User is logged on to the UAIM Server, the UAIM Server can authenticate the user to UAIM enabled or registered sites.

The UAIM Server provides a combined user authentication and identity management service for the distributed client/server network environments, such as the Internet. Through the UAIM Server, users are provided with a single username for the Web and a reliable means of authentication without compromising their privacy. The UAIM Server also provides sites with reliably authenticated users and a means of gathering user demographics without imposing lengthy registration processes.

By becoming an UAIM enabled site, Web sites and other restricted resources can expedite their registration process and gain a reliable means of user authentication thereby: increasing the number of registered users; increasing the “stickiness” of users; increasing confidence in the identity of users; decreasing the number of duplicate signups; and increasing the validity of their demographics. By becoming an authorized UAIM User, an individual gains: a single username for all web sites; single sign-on per browser session to all UAIM enabled sites; confidence that it is hard for impostors to pretend to be them; confidence that it is easy to log on without having to remember multiple passwords; virtually instant sign up to any UAIM enabled site; and centralized identity management that permits an individual to update and view the information that each site has about them.

FIG. 6 is an exemplary diagram illustrating the various features and aspects of the invention for permitting a registered UAIM user to log on to a site. As shown in FIG. 6, when an existing UAIM user wishes to sign up to an UAIM enabled site, they can simply click the UAIM button on the site's page (step 62). The query string of the URL for this button contains data encrypted under the site's key using an algorithm that was selected when the site signed up for the UAIM service. This data includes the Site ID (in order to check the decryption) and the required action (logon). Along with the request from the UAIM button click, the user's browser will send the following UAIM cookies (if they have been set): the Username; and the SessionToken. The UserName is a persisting cookie that is set unless the user checks a checkbox to say that they do not want this (e.g., if they are using the service from a public computer). This prevents the need for the user to enter their UAIM username from their client computer. The SessionToken comprises a large random number generated by the UAIM Server for each user session along with the UserName (which may be plain text). The SessionToken cookie is valid for that browser session only and means that the user will need to log on to UAIM Server only once in the duration of any browser session (unless a site explicitly requests that the user must be re-authenticated).

If neither cookie is present when the user clicks the UAIM button, then the UAIM Server will serve also the GetUsername page (step 64 in FIG. 6). If the SessionToken is present, then the UserName cookie is ignored (if present) and the SessionToken is verified against UAIM User's record of the SessionToken. If the value is correct, the user does not have to go through the authentication stage and the process proceeds so that the user can log on to the site (i.e., the process proceeds to step 68 in FIG. 6). If the SessionToken is not present or is invalid, then the user has not logged on to UAIM during the current browser session. In such a case, if the UserName cookie is present, then the UAIM Server assumes that it is correct and presents the authentication page to the user's browser (step 66 in FIG. 6). Preferably, the authentication page that is presented by the UAIM Server includes a set of complex images (such as a set of human faces) to authenticate the user. This set of complex images may be arranged in a matrix and include a true or key image along with a number of dummy or false images. To authenticate oneself, a user is required to select the true image out of the false images that are presented on each page. If the username on the authentication page is incorrect (i.e., multiple users are sharing a single computer), then the user can click the “I'm not <username>” button on the authentication page. This will then take the user to the GetUsername page (see step 64 in FIG. 6).

In order to avoid prevent an attacker from guessing valid usernames and attempting to attack them, the UAIM Sever can present a standard set of complex images for any given username that does not exist. In order for this to be convincing, any username that does not exist will be created, so that the appropriate bad attempts timeout can be simulated. Usernames created for this purpose will, however, continue to be available to new UAIM Users (even if they are disabled due to bad logon attempts).

In particular, a possible attack on the UAIM Server might comprise iterating through the potential username space and attempting to log on as each username using a combinations of complex images. For example, such a username search could be biased especially towards combinations of common names. In accordance with an aspect of the invention, the UAIM Server may be adapted to reduces the viability of such attacks by creating “dummy” UAIM User accounts for any log on attempt for a username that does not already exist. These dummy accounts will behave exactly like genuine accounts, except that there will be no combination of key images that will successfully log the unauthorized user on. This feature means that an attacker will spend time and effort attempting to guess the key images of an account that does not exist. The dummy username will be subject to lockouts after a number of bad attempts that will further delay and distract the attacker.

In order to prevent the attacker from making large sections of the username space unavailable by this type of attack, each dummy username may be made available for registration again some time after its creation (e.g., after one day). In such a case, any existing lockout period will continue to be active until a new user actually completes the registration of that username. This means that the attacker will only be able to ascertain that they have been wasting their effort on a particular dummy username after a fixed amount of elapsed time.

To avoid the registration process from leaking information about which usernames are already taken (i.e., if an attacker is allowed to register with the UAIM Server and is assigned a particular name, then that name is eliminated from the attack space on the logon process), the UAIM Server can be implemented to reserve, at all times, a significant number of valid unassigned usernames. Whether a username is reserved or not can be decided at the time it is requested. This decision may be based on a random number to ensure that the reserved usernames cannot be predicted.

Referring again to FIG. 6, once the user has successfully identified their unique set of complex images, the UAIM Server will send the user's browser a redirection to the original site (step 68 in FIG. 6). For this purpose, a redirection URL query string may be provided that includes the user's “usertag” (see below) for that site and the user's “authdetails” (see below). This information will be encrypted under the site's key and selected algorithm.

The usertag is assigned by the site and is used by the site to identify the user. It can be any unique value in the site's database and stored by the UAIM Server on behalf of the site. This allows existing users of the site to change to being UAIM Users—the site may simply use the existing username as the usertag. As the site only refers to the user by their site-unique usertag, the site need never know the UAIM username, thus ensuring a level of privacy for the UAIM User. In addition, this prevents sites from exchanging data about their users by matching up usernames.

If a usertag is present (for a particular user at a particular site), then it indicates to the UAIM Server that the user has an account at that site. The UAIM Server will pass the usertag back to the site when the user requests that UAIM authenticate them to the site. Other than this, the UAIM Server has no interest in the usertags: they are site assigned values which only have meaning to the site which issued them.

The authdetails comprise information about the user's authentication that may include one or more of the following: number of recoveries; last recovery date/time; total logon attempts; bad logon attempts since last logon; date/time of last user authentication data change; and time since logon (possibly 0 if this authentication instigated the logon). For systems in which the user authentication data comprises passwords, the time of “exposure” of the password is typically used as a metric for the quality of the authentication. With the use of complex images, however, exposure is significantly less of an issue although it is arguably still a factor. The unfortunate consequence of providing this type of information (i.e., last user authentication data change) to the site could be that sites then insist the user change their key images before being allowed access to the site. The UAIM Server does not necessarily want to encourage this behaviour and may therefore choose to not include this information. The original site may then decide what level of security to afford the user passed on the authdetails.

FIG. 7 is an exemplary diagram illustrating the various features and aspects of the invention for permitting a registered UAIM user to sign up or register to a site. As illustrated in FIG. 7, if a UAIM User wants to register with a site (at which they are not already signed up), as with logon, they simply click the UAIM button on the site (step 70). Thereafter, the transactions between the user's browser, the site and the UAIM Server is identical to that described above for logging on to a site (compare FIGS. 6 and 7). In summary, referring to FIG. 7, the UAIM button directs the user's browser to the UAIM Server (step 70). If the user has already logged on to UAIM in the current browser session, then they will have a valid SessionToken cookie that will result in the authentication phase being skipped (i.e., the process proceeds directly to step 76 in FIG. 7). Otherwise the user will be required to enter their username (unless they have a UserName cookie) and then identify their key complex images (steps 72 and 74). Once they have identified their key images, UAIM issues a SessionToken cookie to the user's browser (meaning that they are logged on to UAIM) and redirects them back to the originating site with a redirection URL query string containing the usertag and authdetails (steps 76 and 78).

Since the user is not already registered with the site, they will not have a usertag for the site in their UAIM account. The UAIM Server will therefore return an empty usertag. indicating to the site that, despite being an authenticated UAIM, the user is not signed up. The site then sends the user a redirection back to the UAIM Server (go back to step 70 in FIG. 7), this time with “action=sign−up.” Additional parameters that the site may set for the signup action are: the UserTag; and the GetCard. The usertag to set for this user. If the user already has a usertag for the site, then it will be overwritten with this value. If the supplied value is empty, then the UAIM Server will generate a value that is unique to the site (which will be returned to the site when UAIM redirects the user back to the site at the end of this transaction). If true this request will return the User Card information (see below).

As the user is already in possession of a SessionToken cookie (i.e. they are logged on to UAIM), they will not need to identify their key images again but will proceed directly to complete the User Card page (step 76 of FIG. 7). If, however, for any reason, the site has instigated the sign up process when the user is not already logged on, the SessionToken will be absent or invalid and the user will be required to logon to the UAIM Server as previously described. As shown in FIG. 11A, the User Card may comprise a number of user detail fields that correspond to ECML and/or UAIM specified tags. (ECML only covers common E-commerce transaction field names. It does not specify the sort of information commonly associated with site registration (e.g. date of birth, occupation, gender, residential address, email address etc). As a result, it may be necessary to augment the ECML with UAIM own custom field names). The UAIM Server “knows” which tags the site considers mandatory and which it considers optional (as the UAIM Server stored this information when the site was signed up to UAIM). The User Card page can, therefore, indicate the mandatory fields that must be sent and the optional fields that the user can omit if necessary. The user then gives permission to the UAIM Server to pass on this information (e.g., by checking or unchecking checkboxes next to each optional item) and fills in or modifies the fields as necessary.

As further shown in FIG. 11A, the bottom of the User Card page includes various buttons including SEND and SAVE buttons. The SEND button, when selected, will send the information from the User Card as displayed to the site. The SAVE button, when selected, will save this information from the User Card as displayed in the UAIM database for use next time. This approach gives the user the option to provide “one off” alternate information without modifying the usual stored information. An extension to this mechanism would be for each field to contain a history of all values that have been previously entered in that field by the user, for example, displayed as a drop down list. The user can then select which response they wish to “send” for any field, the default response for each field being the most recent one to be “saved”. If the user wishes to enter a new value then they can click a radio button or check box to toggle the mode of the selection/text field. Alternatively, the User Card could implement multiple user profiles if a simple, intuitive user interface to achieve this could be realized. User profiles, however, are potentially confusing, since the user needs to give them names (which may cause confusion with their UAIM username). The functionality afforded by profiles (e.g. my identity at work, my identity at home etc) can be achieved simply by recommending that users alias (or clone) their accounts thereby creating multiple UAIM usernames to reflect their multiple personalities. All of an individual's aliased accounts will have the same set of key images (if the user changes their key images for one account, all of the accounts will change) and will initially inherit the User Card details from the account being aliased. The user can then modify each alias account to reflect the identity that it represents (e.g., enter work phone numbers, work e-mail addresses, etc).

The advantage to having account aliases over profiles is that each alias can create a separate account a particular Web service. For example, a UAIM User may have separate email accounts for each of their aliased identities. All are authenticated with the same set of key images, but will automatically log the user into the appropriate account at their Web e-mail provider. An additional example of a User Card page is illustrated in FIG. 11B.

Once the user has clicked the SEND button on the User Card, their browser will be sent a redirection to the original site (using the URL that the UAIM Server has stored for the site). This redirection's query string will contain the ECML tags and values from the User Card along with the usertag (as originally provided by the site). All of this information will be encrypted under the key and algorithm specified by the site (see step 78 in FIG. 7). The UAIM Server's response will also set the SessionToken cookie to ensure that the user continues to be logged on to UAIM as long as they periodically access the UAIM Server. In order to avoid the length restriction imposed by the query string, the ECML tags could be abbreviated to single letter UAIM equivalent tags. Alternatively, the response could be a hidden form, automatically submitted by Javascript. In this manner, the site will be receive all of the mandatory sign up fields that it might require from the User card and will only have to prompt the user for any additional service specific details which are not part of the User Card (or ECML).

Should a user wish to streamline the sign up experience, an “advanced” option within the UAIM Server could allow them to configure their UAIM account so that their User Card is automatically sent to certain categories of site without their intervention. If this is the case then, if a UAIM User is already logged on to the UAIM Server, they could sign up to a UAIM enabled site with a single click of the UAIM sign-up button.

FIG. 8 is an exemplary diagram illustrating the various features and aspects of the invention for permitting a non-registered UAIM user to enroll and sign up to a site. As shown in FIG. 8, if a user who has not already signed up for UAIM clicks on a site's UAIM button (step 80), they will not have a UserName cookie and so will get served the GetUsername page (step 82). Alternatively, if for any reason someone else's UserName cookie exists on the computer they are using, they can click the “I'm not <username> . . . ” button on the authentication page to have the GetUsername page (see step 82 in FIG. 8). The GetUsername page contains a button to sign up to UAIM, which will perform the complex image enrollment process (steps 83 and 84) and then redirect back to the original site as normal (i.e., passing back an empty usertag indicating to the site that the user is not already signed-up or registered). Recognizing that the user is not already registered (as their usertag is empty), the original site can now redirect the user's browser to the UAIM Server (with “action=sign-up”) sending a new, unique usertag for the user along with the redirection query string. Because the user is now enrolled at the UAIM Server and is logged on in the current browser session, their usertag for the site will be saved at the UAIM Server. In such a case, the user will proceed directly to the User Card (step 86 in FIG. 8) in order to return the registration information that the site requires. That is, once the user has clicked the SEND button on the User Card, their browser will be sent a redirection to the original site (using the URL that the UAIM Server has stored for the site). This redirection's query string will contain the ECML tags and values from the User Card along with the usertag (as originally provided by the site). All of this information will be encrypted under the key and algorithm specified by the site (see step 88 in FIG. 8).

So far, the entry point to the UAIM Server has been from a UAIM button. It is possible, however, for the user to visit the UAIM Server directly to enroll or log on. When a user visits the UAIM Server directly and enrolls, they will be given the option to complete their User Card immediately after the complex image enrollment or to leave this until later when they first enroll at a UAIM enabled site.

Visiting the UAIM site directly also makes available a number of other user account pages, such as the following:
UAIM introduction, security information, help and FAQs
UAIM background and reassurances
UAIM User Area:
   User Card
   User Settings
      Enable/disable automatic disclosure of User Card options (as discussed above, this feature may not be desirable)
      Change Email address, e.g., for recovery
      Change key complex images
      Delete account
      Change UserName
      Create alias account (new UAIM UserName, same key images, same initial User Card) allows multiple personalities (i.e. multiple accounts at UAIM enabled sites)
      View aliases
User Information
   Number of bad attempts
   Number of recoveries
   Date of last recovery
User History (a user viewable audit trail)
UAIM User Directory (sites that welcome UAIM Users)

A user can also get to the UAIM Server from the authentication page (the only page that need ever be shown every session). By checking a check box on the authentication page, the UAIM Server will cause a pop up in a separate browser once the key images have been selected correctly by the user. Meanwhile, the site where the user was originally signing up to or logging on to will be displayed (via the final UAIM redirection) in the same browser as the authentication page as normal.

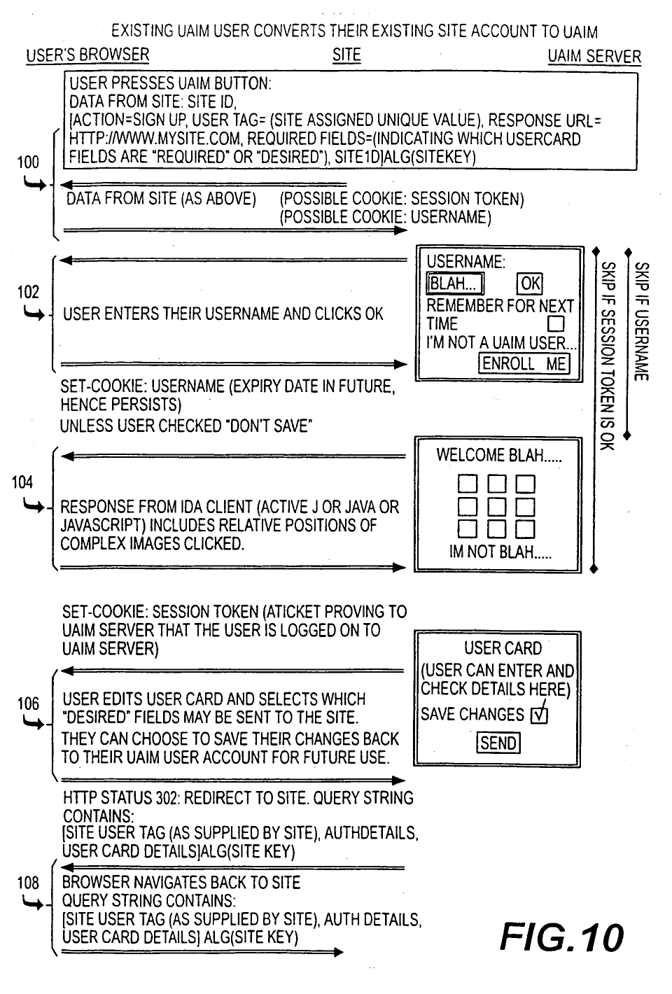

FIGS. 9 and 10 are exemplary diagrams illustrating the various features and aspects of the invention for permitting a user to convert their existing site account to UAIM. In particular, FIG. 9 illustrates an example of a situation of where a non-UAIM User converts their existing site account to UAIM and enrolls as a UAIM User along the way. In contrast, FIG. 10 illustrates an example of a situation where an existing UAIM User converts their existing site account to UAIM. As will be appreciated from these examples, sites can offer their users an easy path to change their existing site accounts to use UAIM authentication, regardless of whether the user is already a UAIM User. All the site has to do when a user invokes UAIM sign-up (by clicking a UAIM button) is to set the usertag to the user's existing username at the site (see step 90 in FIG. 9 and step 100 in FIG. 10). The user can then enroll and/or log on at the UAIM Server as necessary and, thereafter, use their UAIM username to log on to their existing account at the original site (see steps 92-98 in FIG. 9 and steps 102-108 in FIG. 10).

Other features and aspects may be provided with the UAIM Server, in accordance with the invention. For example, procedures may be provided to assist the user if they need to recover or change their key images for authentication. For instance, if a user gets their key images wrong when logging on, they are can be allowed three attempts before a delay of five minutes on further logon attempts is imposed. After this initial time has expired, any further bad logon attempts will result in the delay being doubled. When the user gets their key images correct the logon delay is reset. In order to avoid denial of service attacks on individual accounts and to recover users who, for whatever reason, are unable to remember their key images, any user may request a recovery e-mail. This e-mail message will be sent to the recovery email address that they gave when they created their UAIM account (or may be subsequently changed via the User Settings page of the UAIM site). The e-mail contains a URL containing a RecoveryToken that allows the user to reset logon delay on their account and thereby to try logging in again, be reminded of their key images (and practice with them again) or to be given a new set of key images (and decoys).

Other mechanisms for recovery can be implemented to cover the situation where a user cannot access their e-mail account (e.g., if it is accessed via UAIM authentication). For example, a telephone number given at enrollment time could be used to contact the user in trouble and verify their identity using “personal entropy” type information about their use of their UAIM account. Alternatively, the information otherwise sent through a recovery e-mail could be sent to the user using ordinary mail.

UAIM users should be able to change their key images (by going to the UAIM Server or by using a predetermined recovery process). Although users should be made aware that key images are not as vulnerable as passwords, and so do not necessarily need to be changed frequently (or at all unless exposed), users should be permitted to change their key images at their own discretion. Also, whenever a user changes their key images, the UAIM Server can select, at random, a new set of key images (and a new set of decoys to avoid confusion). This option is feasible as long as there is a new set of key images available that they have not already used. Additionally, at any time, the user can choose to revert to their most recent previous set of key images (and decoys). In this manner, it is always possible for users to change from a set of key images that may have been exposed or that the user finds difficult to remember. The UAIM Server can start with at least two sets of male and female key images (allowing all users at least one change of key images). Additional sets of key images can be added at regular intervals allowing users to change their key images to new sets as often as face sets are added. After changing or reverting to a previous set of key images, the user will be taken through the standard practice with their key images as they did when they first enrolled.

Using a similar mechanism to the recovery process outlined above, if a user wishes to delete their UAIM account, they will be sent a confirmation e-mail to their recovery address which will enable them to confirm that their account should be deleted. This mechanism prevents accidental deletion of an account, as well as allowing accounts to be deleted regardless of whether the user is able to log on. Other recovery mechanism could also be utilized, such as a recovery letter or document sent through ordinary mail.

As discussed above with reference to FIGS. 11A and 11B, a uniform User Card page may be displayed to the user to gather information during registration. The use of a uniform and consistent interface for supplying personal information has many benefits. Currently, Web service and e-commerce sites require users to complete non-standard forms to supply such personal information as is necessary. Users are required to provide such information to either enroll at a Web-based service or, in the case of an e-commerce site, checkout. This information typically includes some or all of the following: the user's name; residential address; billing address; shipping address; receipt address; payment details (e.g. credit card number, issue number, expiry date); and demographic details (e.g. date of birth, gender etc). Each Web site requires different combinations of data from users, has different names for each data item and presents the user with a different graphical and textual interface through which they must provide the required information in order to complete the process.

In accordance with an additional aspect of the invention, the logon server and UAIM Server of the present invention may be implemented to standardize this process, giving the user a familiar user interface. A User Card interface, such as that illustrated in FIGS. 11A and 11B, permits users to select, complete and customize the data that they wish to send to the site in each instance. The user interface preferably includes the ability to show the user which fields the site has requested by indicating those fields that the site considers optional and those that the site regards as mandatory in order to complete the requested process. In addition, through the User Card interface of the present invention, the user can review the default information presented by the logon server or UAIM Server, select from information that they have previously sent to this or other sites, or enter new information. The user can also choose which of the optional fields should be sent to the site. For example, a site sign up process may request a number of fields that need not be completed at this point. The user can decide, in this scenario, whether the information will be provided at sign up time, or later when the site actually needs it to complete a transaction. Additionally, the user can choose whether new information in any category should be saved back to the logon server or UAIM Server for use in future sessions. When the user is happy with the information displayed, they click the “OK” button to transmit the information to the site.

With this process, the user becomes familiar with the layout of the User Card and knows where changes will need to be made to the details contained within it for each transaction they perform. Also, as the logon server or UAIM Server will have verified that the user has supplied all of the data required by the site, it will not be necessary for the site to re-prompt the user for this information or to return them to the server to obtain it. Consequently, the required information can be accurately transferred to the site, under the user's control and with minimum effort.

The following exemplary tables illustrate the data item collections that can be stored in the database of the logon server or UAIM server of the present invention.

TABLE 1
User Table (one of these records exists per user name)

| Item | Description |
|---|---|
| Session Token | A server generated random string which is issued |
| | as a cookie when a user logs on |
| UAIM Tag | Uniquely identifies a UAIM User in the key |
| | images and audit databases (allows for |
| | change of UAIM UserName without loss of |
| | audit history). |
| Key images Iteration | How many times have they changed their key |
| | images, also used to ensure that when they next |
| | change their key images they get a set of key |
| | images + decoys with the largest possible number |
| | of changes before repetition |
| Last Logon Time | The date/time of the last logon as a long integer |
| Current Logon Time | The last logon or access time if logged on or zero |
| | if not logged on. Used to indicate whether the |
| | user is currently logged on and to automatically |
| | expire logon after a fixed period of inactivity. |
| LogonAudit ID | Identifying the LogonAudit record of the key |
| | images authentication which started the current |
| | session |
| Enrol Time | Date/time of original enrollment as a long integer. |
| EnrolAuditID | Identifying the EnrolAudit record of when the |
| | UAIM User account was created |
| Bad Attempts | Current count of bad key images attempts. Reset |
| | to zero after a successful user's selection of key |
| | images |
| Total Bad Attempts | Total count of all bad key images attempts on this |
| | account. |
| Recovery ID | A SessionToken for recovery |
| Last Recovery Time | Date/time of when the user last successfully |
| | recovered as a long integer |
| Total Recovery Count | Total count of all successful recoveries on this |
| | account. |
| Total Logons | Total count of all successful logons on this |
| | account. |
| Last Key images | Date/time of when the user last changed their key |
| Change Time | images |
| User Card | A number of ECML (and other) tags and values. |
| | (If the User Card offers a history of each value, |
| | then multiple values will be stored for each tag.) |

Key Images Record (Per User)

This record is indexed by the UAIM User Tag (from the User Record). It contains the key images and decoys per user per grid. It is envisioned that this will located in a physically separate database connected by a thin API to reduce the possibility of data leaks. The only operations possible on this information are: (1) to update the key images+decoys per grid; (2) to read a shuffled list of the key images+decoys per grid; and (3) to check a number of key images.

It should not be possible or necessary to ever read the user's key images from this record. This record can by split by grids across multiple physical locations if required.

TABLE 2
Tags Table (one of these records exists for each UAIM to
usertag correspondence)

| Item | Description |
|---|---|
| UAIM Tag | Obtained from the User Table |
| Site ID | Selects a unique Site Table |
| | record |
| Site Tag | The site defined usertag for the |
| | user at the site |

TABLE 3
Site Table (one of these records exists for each UAIM enabled
site)

| Item | Description |
|---|---|
| Site ID | A unique value identifying the |
| | site |
| Encryption Key/ | Encryption key with algorithm |
| Algorithm ID from site | identifier to use for encrypted |
| | data received from the site (via |
| | the user's browser). May also |
| | indicate that the site wants to |
| | send info in plaintext. |
| Encryption Key/ | Encryption key with algorithm |
| Algorithm ID to site | identifier to use for encrypted |
| | data sent to the site (via the |
| | user's browser). May also |
| | indicate that the site wants to |
| | receive info in plaintext. |
| Admin Email address | Where to send admin info-e.g. |
| | payment reminders etc |
| Admin User Tag | A UAIM User Tag identifying the |
| | UAIM User account of the |
| | administrator of the site. This |
| | user will need to log on to |
| | perform site admin functions at |
| | UAIM. |
| Mandatory ECML + tags | Which ECML + tags from the |
| | User Card are mandatory. |
| Optional ECML + tags | Which ECML + tags from the |
| | User Card are desired but not |
| | required. |
| Logon credit | How many authentications we |
| | will allow to the site. A |
| | decrementing count which can |
| | be incremented by the site |
| | crediting UAIM with money. |
| Logon credit warning level | When the Logon credit number |
| | drops below this value a warning |
| | email will be sent to the Admin |
| | Email Address |
| Billing details | Whatever is necessary here: |
| | e.g. An invoice address, direct |
| | debit instructions or credit card |
| | details. |

The following records can stored for audit and/or billing purposes. They can be considered write once. Only the most recent years' information need be kept online. The site administrator should be able to browse audit information pertaining to their site.

The LogonAudit record shown below in Table 4 is written for every key images authentication and subsequent access via a SessionToken. Where the authentication is by SessionToken, the parent field identifies the LogonAudit that contained the key images authentication which issued the SessionToken

TABLE 4
LoganAudit

| Item | Description |
|---|---|
| Logon Audit ID | A unique identifer for this |
| | record |
| UAIM User Tag | Identifying the UAIM User |
| | Account |
| Successful | Did the key images logon |
| | succeed? |
| Time | Long integer date time of logon |
| IP address | IP address of client |
| Referrer | This will usually be the URL of |
| | the page containing the UAIM |
| | User button |
| Parent | The Audit ID of the LogonAudit |
| | that contained the actual key |
| | images authentication for this |
| | session |

TABLE 5
EnrollAudit (created when a user enrolls as a UAIM User)

| Item | Description |
|---|---|
| Enroll Audit ID | A unique identifier for this |
| | record |
| UAIM UserName | The only audit record of the |
| | UAIM UserName (except for |
| | when changing UAIM |
| | UserName) |
| Logon Audit ID | The associated logon audit |
| | should contain all the other |
| | fields we might want to audit. |

TABLE 6
Site Signup Audit (created when a user signs up at a new
site)

| Item | Description |
|---|---|
| Site Sign Up Audit ID | A unique identifier for this record |
| | or the SessionToken were |
| | authenticated. |
| Site ID | The ID of the site that we are |
| | authenticating to. |
| Site User Tag | The usertag as provided by the |
| | site |

TABLE 7
AuthAudit (created when UAIM authenticates a user to a site)

| Item | Description |
|---|---|
| Auth Audit ID | A unique identifier for this |
| | record |
| Logon Audit ID | The ID of the LogonAudit that |
| | resulted when the key images |
| | or the SessionToken were |
| | authenticated. |
| Site ID | The ID of the site that we are |
| | authenticating to. |
| Site User Tag | The usertag as passed to the |
| | site |

The Log Off Audit shown below in Table 8 is created if a user explicitly logs off from the UAIM Server. Note that this is more secure than simply closing the browser and letting their logon expire. Explicitly logging off prevents anyone who may have captured the SessionToken (despite it travelling over SSL) from using the account. An IE5 browser button can be made available for download to log off.

TABLE 8
Log Off Audit

| Item | Description |
|---|---|
| Log Off Audit ID | A unique identifier for this record |
| Logon Audit ID | The corresponding Logon Audit |
| | contains all of the other info that |
| | might be required |
| Time | Date and time as a long integer |

TABLE 9
SendRecoveryAudit (created when a user requests a recovery
e-mail from UAIM)

| Item | Description |
|---|---|
| Send Recovery AuditID | A unique identifier for this record |
| UAIM User Tag | Identifying the user |
| Time | Date and time as a long integer |
| Recovery E-mail Address | Where the recovery e-mail was sent |

TABLE 10
Recovery Audit (created when a user recovers their account
using the recovery email sent by UAIM)

| Item | Description |
|---|---|
| Recovery Audit ID | A unique identifier for this record |
| Send Recovery Audit ID | The audit record of the request |
| | that resulted in this recovery |
| UAIM User Tag | Identifying the user |
| Time | Date and time as a long integer |
| Bad logon attempts | Current count of bad logons |
| | (logon delay can be inferred |
| | from this). |
| Recovery type | Log on/Change Key images |

TABLE 11
Change Key images Audit (created when
a user changes their key images)

| Item | Description |
|---|---|
| Change Key images Audit ID | A unique identifier for this record |
| UAIM User Tag | Identifying the user |
| Time | Date and time as a long integer |

TABLE 12
Change UAIM UserName Audit (created when
a user changes their UAIM User Name

| Item | Description |
|---|---|
| Change UAIM User Name Audit ID | A unique identifier for this record |
| UAIM User Tag | Identifying the user |
| Time | Date and time as a long integer |
| Old UAIM User Name | Old UAIM User Name |
| New UAIM User Name | New UAIM User Name |

TABLE 13
Clone Account Audit (created when a user makes
a duplicate account with the same key images)

| Item | Description |
|---|---|
| Clone Account Audit ID | A unique identifier for this record |
| Existing UAIM User Tag | Identifying the existing account |
| New UAIM User Tag | Identifying the new account |
| Time | Date and time as a long integer |

In order to become a UAIM enabled site, the site administrator can perform a Web based “site enrollment” process. The site administrator must have (or must create) a UAIM account for themselves. They will then fill in a form which creates the Site Record. This will involve generating encryption keys, choosing encryption algorithms and providing billing details. They will receive a unique Site ID for their site. Thereafter, once they have logged on to UAIM they can monitor and update site settings, make payments to UAIM and interrogate audit trail events pertaining to their Site ID. A Software Developers Kit (SDK) may be provided to sites that contains source code (in both C and Perl) to implement the various supported encryption algorithms, along with example code and HTML to enable sites to create and receive redirections to and from the UAIM Server.

For billing purposes, site administrators may either “charge-up” their UAIM account by providing their credit card details and specifying an amount to debit. This will increment their UAIM authentication credits effectively paying in advance for a fixed number of authentications. This approach allows even very small sites to become UAIM enabled. The site administrator will receive an e-mail informing them when the credit has reached a low value of their choice.

Alternatively, larger sites may be given UAIM credit and will be invoiced monthly by an automated process which analyses the site records in conjunction with the audit logs and can produce an itemized statement if required.

There are competing design goals for the UAIM system architecture. These include: speed and reliability of access; data security/integrity; and continuity of service/fault tolerance. These goals can be achieved within a single UAIM server site by using standard off the shelf or custom solutions to provide server load balancing, scalability and redundancy. Data security within a single site can be accomplished by physically separating the database servers from the high volume page content servers. A restricted API to database servers that only allows certain specific requests to be served from each server will make security analysis easier. Splitting the database across physically separate servers according to function will further untangle the implementation complexity from the security analysis. For example, the key image records could be kept on one database server while the user records, site record and audit records could be kept on another database server. Each server interface can then be responsible for “gatekeeping” its access. Communications between physically separate servers would be secured using standard peer to peer public key based cryptographic techniques.

Each individual database server may be implemented to have its database stored encrypted with the encryption key present only in memory and will be physically enclosed in a tamper resistant mechanism. This can help to ensure that even if the servers are stolen, they will not yield their data.

To implement the UAIM service, UAIM servers may be provided in a number of regions throughout the world. Several advantages can be gained from implementing such an arrangement. First, regional UAIM enabled services could redirect their users to the nearest (or best connected) UAIM server for authentication thereby avoiding redirections across internet backbones which may already be overloaded at certain times in certain areas. Second, fault tolerance and continuity of service can be achieved by allowing a regional UAIM server to take over the traffic from another regional server which may be experiencing connectivity problems. Third, data security could be potentially enhanced by splitting the key images record across multiple sites.

It will be apparent to those skilled in the art that various modifications and variations can be made in the disclosed embodiments. For example, the features and aspects of the disclosed embodiments may be combined, modified or substituted to provide additional advantages and features. Thus, the features disclosed herein with reference to the logon server and UAIM Server may be combined, modified or substituted. In addition, other embodiments of the invention will be apparent to those skilled in the art from consideration of the specification and practice of the invention disclosed herein. Furthermore, it is intended that the specification and examples be considered as exemplary only, with a true scope and spirit of the invention being indicated by the following claims.

1. A distributed client/server computer system comprising a network of servers and clients in which user access to restricted resources administered by at least some of said servers is controlled by a logon procedure that identifies an authorized user to the respective administering server, which system includes a logon server accessible by a plurality of clients, and the logon server is provided with:
a user authentication procedure by means of which a user can log on to the logon server from one of said plurality of clients and use said authentication procedure to uniquely identify that user to the logon server;
a stored library, specific to a user of the logon server, of network addresses of user-selected resources, including restricted resources, and of user data to satisfy logon procedures for the user to access the restricted resources; and
means for detecting a request from a logged-in user through a given client for access to data from a resource, and, in the case of a restricted resource, for then carrying out at least one of the following procedures:
(i) using the stored library of user data to complete a user logon procedure for that resource on behalf of the user to log the user on to the resource, receiving the requested data from the server administering the resource, and forwarding the said data to the client by which it was requested;
(ii) using the stored library of user data to prepare a user logon form for that resource on behalf of the user and forwarding the said form to the client by which it was requested for the user to submit to that resource to log the user on to that resource; or
(iii) using the stored library of user data to partially complete a user logon form for that resource on behalf of the user, serving the partially complete form to the client, receiving the form from the client after the insertion of data by the user, and adding data inserted into the form by the user to the library for recall for future use in procedure (i) or (ii).

2-50. (canceled)
